(19) United States
(12) Patent Application Publication
(10) Pub. No.: US 2015/0129000 A1
(43) Pub. Date: May 14, 2015

(54) APPARATUS FOR CLEANING A SUBSTRATE

(71) Applicant: SAMSUNG DISPLAY CO., LTD., Yongin-City (KR)

(72) Inventors: Seok Jun JANG, Chungcheongnam-do (KR); Bong Kyun Kim, Gyeonggi-do (KR); Yang II Jeon, Chungcheongnam-do (KR)

(21) Appl. No.: 14/463,848

(22) Filed: Aug. 20, 2014

(30) Foreign Application Priority Data
Nov. 13, 2013 (KR) 10-2013-0137606

(51) Int. Cl. B08B 3/02

(52) U.S. Cl. CPC B08B 3/022
USPC 134/102.2; 134/151

(57) ABSTRACT

An apparatus for cleaning a substrate includes a substrate transferring unit configured to support a substrate at a polar angle from a first direction, and transfer the substrate along a second direction orthogonal to the first direction. A cleaning unit is disposed on the substrate transferring unit. The cleaning unit includes a plurality of two-fluid nozzles. The cleaning unit has an azimuth angle from the first direction. The two-fluid nozzles mix a cleaning solution and compressed gas together and spray the mixture.

### CROSS-REFERENCE TO RELATED APPLICATION

This application claims priority under 35 U.S.C. §119 to Korean Patent Application No. 10-2013-0137606, filed on Nov. 13, 2013 in the Korean Intellectual Property Office the disclosure of which is incorporated by reference herein in its entirety.

### TECHNICAL FIELD

Exemplary embodiments of the present invention relate to an apparatus, and more particularly to an apparatus for cleaning a substrate.

### DISCUSSION OF RELATED ART

Flat panel display devices may be manufactured by processes of film deposition, exposure, etching, and the like. Such processes may cause pollution when very small particles of less than or equal to 10 μm, such as various organic or inorganic materials, are attached to a substrate surface. When the processes are performed with such particles adhering to the substrate surface, pinholes or pits may occur in the film and disconnection or shorts may occur in wires, thereby lowering production yield. Cleaning may be repeatedly performed between respective processes to remove inorganic and/or organic contaminants from the substrate surface.

### SUMMARY

Exemplary embodiments of the present invention are directed to an apparatus for cleaning a substrate capable of preventing reattachment of particles removed from the substrate and capable of preventing hydroplaning resulting from sprayed cleaning solution.

According to an exemplary embodiment of the present invention, an apparatus for cleaning a substrate includes a substrate transferring unit configured to support the substrate at a polar angle from a first direction and transfer the substrate along a second direction orthogonal to the first direction. A cleaning unit is disposed on the substrate transferring unit. The cleaning unit includes a plurality of two-fluid nozzles. The cleaning unit has an azimuth angle from the first direction. The two-fluid nozzles mix a cleaning solution and compressed gas together and spray the mixture.

The cleaning unit may have an azimuth angle of 10 degrees to 45 degrees.

The plurality of two-fluid nozzles disposed on the cleaning unit may be spaced apart at a distance of about 30 mm to about 50 mm from each other.

The cleaning solution may include deionized water (DIW).

The substrate transferring unit may have an angle of about 5 degrees to about 20 degrees from the cleaning unit.

The two-fluid nozzles may have a polar angle of about 15 degrees to about 45 degrees from a normal line perpendicular to the substrate.

The cleaning unit may include a plurality of sub-cleaning units having different azimuth angles from the first direction.

The cleaning unit may include a first sub-cleaning unit on an upper part of an inclined surface of the substrate and a second sub-cleaning unit on a lower part of the inclined surface of the substrate. The first sub-cleaning unit may have an azimuth angle larger than the second sub-cleaning unit.

The cleaning unit may include a plurality of sub-cleaning units having the same azimuth angle from the first direction and disposed parallel to each other.

The distance between the two-fluid nozzles may be smaller from the upper part of the substrate to the lower part of the substrate.

According to exemplary embodiments of the present invention, the apparatus for cleaning a substrate may include a cleaning unit that is disposed to be inclined at a predetermined angle with respect to an imaginary line parallel to the inclination direction of the substrate. The cleaning unit may clean the inclined surface of the substrate sequentially from the upper part to the lower part, so that particles removed from the upper part may be prevented from re-adhering to the lower part.

According to exemplary embodiments of the present invention, the apparatus for cleaning a substrate may prevent the cleaning solution from being concentrated in the lower part, thereby preventing a physical hitting force of the cleaning solution from being reduced in the lower part.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a diagram illustrating an apparatus for cleaning a substrate;

FIG. 2 is a diagram illustrating an apparatus for cleaning a substrate according to an exemplary embodiment of the present invention;

FIG. 3 is a diagram illustrating a two-fluid nozzle of the apparatus for cleaning a substrate of FIG. 2;

FIG. 4A is a diagram illustrating a spray method of a nozzle, and FIG. 4B is a diagram illustrating a spray method of a two-fluid nozzle for cleaning a substrate according to an exemplary embodiment of the present invention;

FIG. 5 is a side view illustrating the apparatus for cleaning a substrate of FIG. 2;

FIG. 6 is a diagram illustrating an installation angle of the two-fluid nozzle in the apparatus for cleaning a substrate of FIG. 2; and

FIGS. 7 to 9 are diagrams illustrating apparatuses for cleaning a substrate according to exemplary embodiments of the present invention.

### DETAILED DESCRIPTION

Hereinafter, exemplary embodiments of the present invention will be described in more detail with reference to the accompanying drawings. However, the described embodiments may be modified in various different ways and should not be construed as limited to the embodiments disclosed herein.

Throughout the specification, it will be understood that when an element is referred to as being “connected” to another element, it may be “directly connected” to the other element or “electrically connected” to the other element with intervening elements therebetween. Like reference numerals may refer to like elements throughout the specification and drawings.

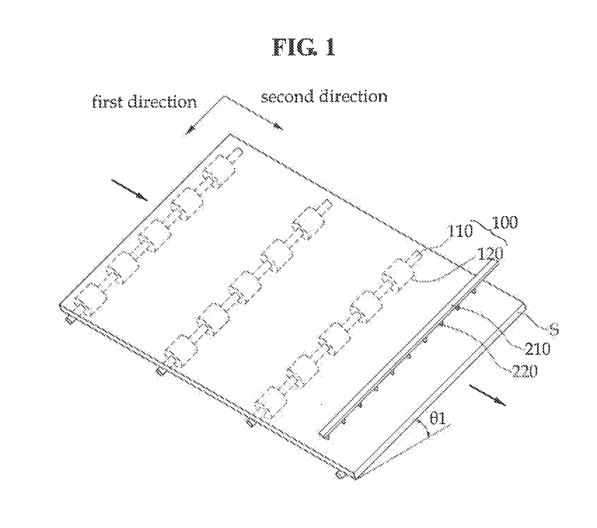

FIG. 1 is a diagram illustrating an apparatus for cleaning a substrate.

Referring to FIG. 1, the apparatus for cleaning a substrate may include a substrate transferring unit 100 that supports substrate S with a predetermined polar angle θ1 perpendicular to a first direction. The substrate transferring unit 100 may transfer the substrate S along a second direction orthogonal to the first direction. The substrate transferring unit 100 may include a cleaning unit 210 that is disposed on the substrate transferring unit 100. The cleaning unit 210 may spray a cleaning solution onto the substrate S through a plurality of two-fluid nozzles 220 coupled to the cleaning unit 210. The two-fluid nozzles 220 may be coupled to a bottom portion of the cleaning unit 210. The substrate transferring unit 100 may include a shaft 110 and a roller 120 and may support the substrate S in an inclined position.

The substrate transferring unit 100 may have a predetermined polar angle θ1 from the first direction. The substrate transferring unit 100 may be configured to separate the particles removed by the sprayed cleaning solution from the substrate S. Hereinafter, an upper part of an inclined surface of the substrate S may be referred to as an “upper part,” and a lower part of the inclined surface of the substrate S may be referred to as a “lower part.”

As a substrate of a flat panel display increases in size, the particles removed from the upper part may adhere to the lower part. Thus, a cleaning solution may be densely sprayed onto the lower part; however, a hydroplaning may occur, thereby reducing a physical hitting force of the cleaning solution sprayed onto the lower part.

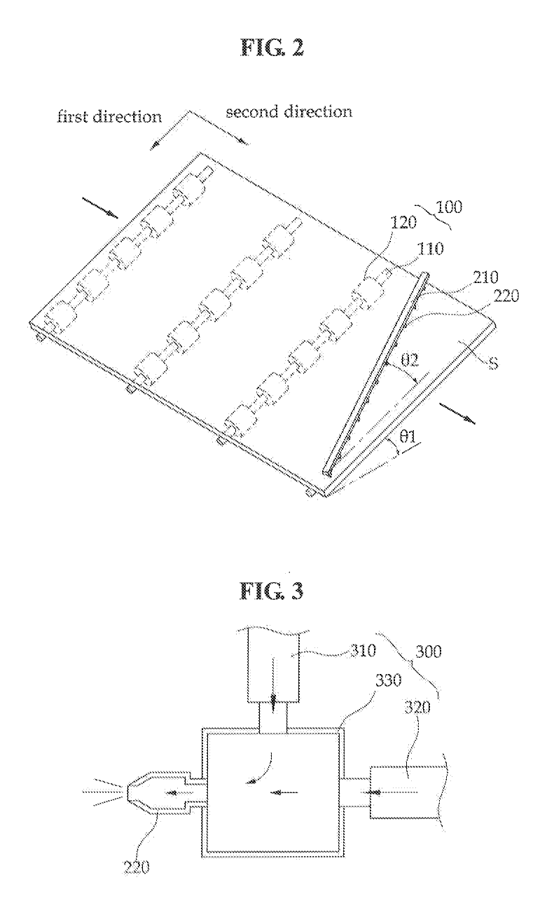

FIG. 2 is a perspective view illustrating an apparatus for cleaning a substrate according to an exemplary embodiment of the present invention.

Referring to FIG. 2, the apparatus for cleaning a substrate according to an exemplary embodiment of the present invention may include a substrate transferring unit 100 configured to support a substrate S with a predetermined polar angle θ1 from a first direction. The substrate transferring unit 100 may be configured to transfer the substrate S along a second direction orthogonal to the first direction. The substrate transferring unit 100 may include a cleaning unit 210 disposed on the substrate transferring unit 100 and provided with a plurality of two-fluid nozzles 220. The cleaning unit 210 may have an azimuth angle 82 from the first direction. The two-fluid nozzles 220 may mix a cleaning solution and compressed gas together and spray the mixture.

The substrate transferring unit 100 may have the polar angle θ1 from the first direction and particles removed by spraying the cleaning solution may be separated from the substrate S. According to an exemplary embodiment of the present invention, the polar angle θ1 may be in a range of about 5 degrees to about 15 degrees. However, the range of the polar angle θ1 is for exemplary purposes only and is not limited thereto, and the polar angle θ1 may be changed to many different angles.

The substrate transferring unit 100 may include a plurality of shafts 110 and a plurality of rollers 120 and may support the substrate S in an inclined position.

The shafts 110 may be spaced apart at a predetermined distance from each other at the same height. The polar angle θ1 of the substrate transferring unit 100 may be selected according to an angle between the shaft 110 and a horizontal plane. The shaft 110 may have a variety of sizes and may include a variety of materials according to a type, size, and weight of the substrate S.

The rollers 120 of the respective shafts 110 may be located at a predetermined distance from each other. For example, the rollers 120 may be rotatably inserted into the shaft 110. The substrate S may be seated on the rollers 120 inserted into the shaft 110 and may be transferred along the second direction by rotating the rollers 120. The rollers 120 may have a variety of sizes and may include materials according to a type, size, and weight of the substrate S.

In addition to the substrate transferring unit 100 including the shaft 110 and the roller 120, any of a variety of substrate transferring apparatuses to transfer a substrate in an inclined state may be used as the substrate transferring unit 100 according to an exemplary embodiment of the present invention.

The cleaning unit 210 may be disposed on an upper portion of the substrate transferring unit 100. A plurality of two-fluid nozzles 220 may be provided on a bottom portion of the cleaning unit 210. The cleaning unit 210 may be supplied with a cleaning solution from a cleaning solution supply source that will be described in more detail below. The cleaning solution may be supplied to the plurality of two-fluid nozzles 220 from the cleaning supply source.

Referring to FIG. 2, the cleaning unit 210 may be inclined to an azimuth angle θ2 of about 1 degree to 89 degrees from the first direction. According to an exemplary embodiment of the present invention, the azimuth angle θ2 may be in a range of about 15 degrees to about 45 degrees, but the azimuth angle is not limited thereto. The azimuth angle θ2 may have variable positions in a range of about 1 degree to about 89 degrees.

The cleaning unit 210 may be inclined to an azimuth angle θ2 from the first direction. This way the cleaning unit 210 may clean the inclined surface of the substrate sequentially from the upper part to the lower part.

When the cleaning unit 210 has the azimuth angle θ2, particles removed from the upper part may flow directly to the lower part and may be prevented from re-adhering to the substrate.

The two-fluid nozzles 220 may be spaced apart at a predetermined distance from each other. The two-fluid nozzles 220 may be disposed on the bottom portion of the cleaning unit 210. For example, when the cleaning unit 210 is inclined to have the azimuth angle θ2, a length of the cleaning unit 210 may be extended, and thus the cleaning power of the cleaning unit 210 may be increased. For example, in a conventional cleaning unit, the cleaning unit may have a width of about 1870 mm, a distance between the two-fluid nozzles may be about 36 mm, and the conventional cleaning unit may include 52 two-fluid nozzles. However, the cleaning unit 210 according to an exemplary embodiment of the present invention may be inclined to an azimuth angle of about 15 degrees so that the length of the cleaning unit 210 may be extended to about 170 mm, and thus the cleaning unit 210 may include about 7 two-fluid nozzles 220.

When the cleaning unit 210 is not inclined to have the azimuth angle θ2, the cleaning solution may be partially prevented from being sprayed onto the lower part. A physical hitting force of the cleaning solution in the lower part may be reduced due to hydroplaning.

The two-fluid nozzles 220 may be spaced apart at a predetermined distance from each other on the bottom portion of the cleaning unit 210. According to an exemplary embodiment of the present invention, the distance between the two-fluid nozzles 220 may be in a range of about 30 mm to about 50 mm. However, the distance is not limited thereto, and may vary depending on a type and/or size of the substrate S.

FIG. 3 is a diagram illustrating a two-fluid nozzle of the apparatus for cleaning a substrate according to an exemplary embodiment of the present invention.

A spray nozzle used in the apparatus for cleaning a substrate may be classified into two types. For example, a single-fluid nozzle and a two-fluid nozzle. The single-fluid nozzle might spray only cleaning solution, and the two-fluid nozzle might mix the cleaning solution with compressed, gas and spray the mixture. The two-fluid nozzle may increase a velocity of the cleaning solution sprayed from the two-fluid nozzle using compressed gas and spray pressure. The two-fluid nozzle may increase displacement of the cleaning solution, and increase cleaning efficiency.

According to an exemplary embodiment of the present invention, the spray nozzle may include the two-fluid nozzle 220 shown in FIG. 3. The two-fluid nozzle 220 may spray deionized water (DIW). The DIW may be supplied from a cleaning solution supply source 300. The two-fluid nozzle 220 may spray DIW and a compressed gas mixed solution onto the substrate S.

The cleaning solution supply source 300 may include a DIW supply source 310 configured to supply DIW, a compressed gas supply source 320 configured to supply compressed gas (e.g., compressed dry air or nitrogen gas), and a mixing part 330 configured to mix the DIW and the compressed gas supplied from the DIW supply source 310 and the compressed gas supply source 320, respectively.

The DIW may be highly purified water that has its ions, particles, bacteria, microorganism, and dissolved gas removed through an advanced water treatment process (e.g., ion-exchange resin, reverse osmosis, ultrafiltration, or the like). The DIW may be referred to as ultrapure water (UPW). For example, UPW and DIW may be highly purified water that has a resistivity of 18.2 MΩcm at 25° C., and ions and other contaminants measured in parts per billion (ppb) or parts per trillion (ppt). UPW or DIW may increase wafer yield in a semiconductor wafer fabrication process.

The DIW and the compressed gas mixed by the mixing part 330 may be supplied to each two-fluid nozzle 220 and may be sprayed. The DIW and the compressed gas may be mixed to increase removal of particles, and the mixture may be sprayed by the two-fluid nozzle 220.

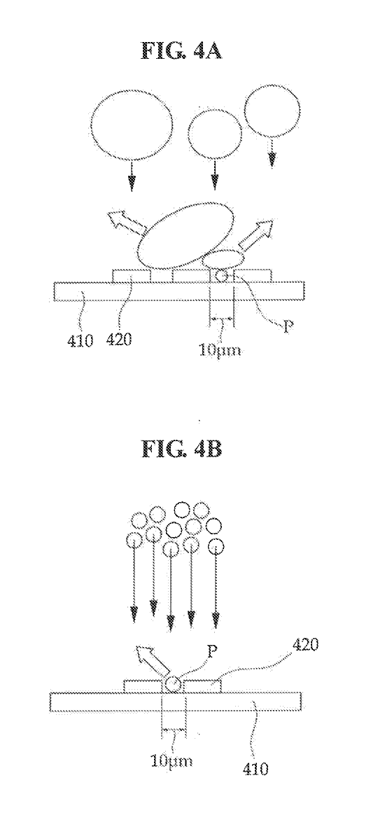

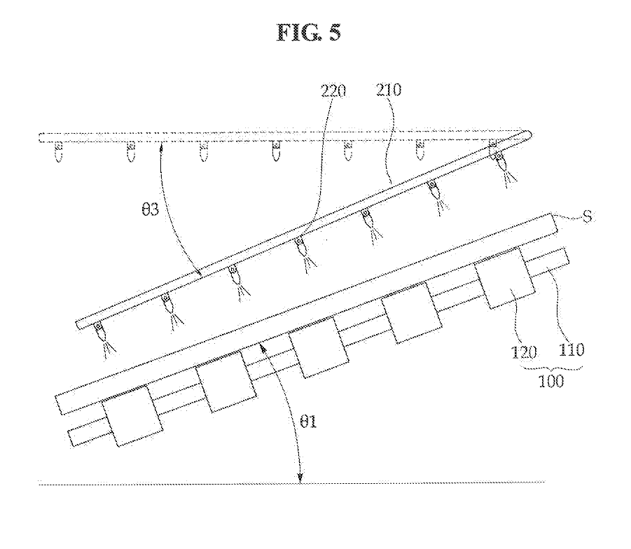

FIG. 4A is a diagram illustrating a spray method of a nozzle, and FIG. 4B is a diagram illustrating a spray method of the two-fluid nozzles in the apparatus for cleaning a substrate according to an exemplary embodiment of the present invention.

As illustrated in FIGS. 4A and 4B, when a distance between fine patterns 420 on a substrate 410 is 10 μm or less, for example, particles P between the fine patterns 420 might not be removed by a spray method of a nozzle (see FIG. 4A) because a size of a sprayed particle is larger than the distance between the fine patterns 420. Particles P between the fine patterns 420 may be removed by the spray method using the two-fluid nozzles 220 (see FIG. 4B). The spray method using the two-fluid nozzles 220 may control amounts of each of the DIW and the compressed gas injected into the two-fluid nozzles 220, and the size of a sprayed particle may be adjusted to be 10 μm or less.

A cleaning method using the two-fluid nozzles 220 may increase the velocity of the cleaning solution sprayed from the two-fluid nozzles 220 using the compressed gas and spray pressure so as to increase displacement of the cleaning solution, and as a result cleaning efficiency may be increased.

A size and velocity of the sprayed particle may be determined by the amounts of the DIW and compressed gas that are mixed with each other, and the amounts thereof may be selected according to a size and type of a pattern of a substrate that will be cleaned.

FIG. 5 is a side view illustrating the apparatus for cleaning a substrate according to an exemplary embodiment of the present invention.

Referring to FIG. 5, the apparatus for cleaning a substrate according to an exemplary embodiment of the present invention may include the substrate transferring unit 100 configured to support the substrate S at the polar angle θ1 from the first direction. The apparatus for cleaning a substrate may include the cleaning unit 210 disposed on the substrate transferring unit 100. The cleaning unit 210 may be configured to spray the cleaning solution onto the substrate S through a plurality of two-fluid nozzles 220 disposed on the bottom portion of the cleaning unit 210.

The cleaning unit 210 may have an installation polar angle θ3 from the first direction. According to an exemplary embodiment of the present invention, the installation polar angle θ3 may be in a range of from 0 degrees to about 15 degrees. According to an exemplary embodiment of the present invention, the installation polar angle θ3 may be substantially the same angle as the polar angle θ1 of the substrate S. However, the installation polar angle θ3 is not limited thereto, and the installation polar angle θ3 may have a higher or lower value than the polar angle θ1 of the substrate S. The substrate transferring unit 100 may have an angle of about 5 degrees to about 20 degrees with respect to the cleaning unit 210. The angle of the substrate transferring unit 100 may be adjusted by adjusting the installation polar angle θ3.

When the installation polar angle θ3 has a higher value than the polar angle θ1 of the substrate S, the physical hitting force of the cleaning solution may increase in the lower part, and the cleaning solution may be prevented from being intensively stagnant in the lower part because of hydroplaning.

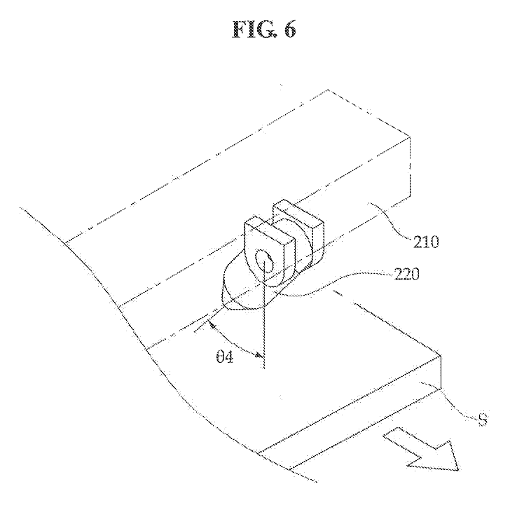

FIG. 6 is a diagram illustrating an installation angle of the two-fluid nozzles in the apparatus for cleaning a substrate according to an exemplary embodiment of the present invention.

Referring to FIG. 6, the apparatus for cleaning the substrate according to an exemplary embodiment of the present invention may include the cleaning unit 210 and plurality of two-fluid nozzles 220. The plurality of two-fluid nozzles 220 may be coupled to the cleaning unit 210. The plurality of two-fluid nozzles 220 may be configured to spray cleaning solution supplied from the cleaning unit 210 onto the substrate S.

The two-fluid nozzles 220 may have a predetermined installation polar angle θ4 from a normal line perpendicular to the substrate S in an opposite direction to a transfer direction of substrate S. According to an exemplary embodiment of the present invention, the installation polar angle θ4 may be in a range of about 15 degrees to about 45 degrees. However, the installation polar angle θ4 is not limited thereto, and the installation polar angle θ4 may be adjustable.

When the installation polar angle θ4 of the two-fluid nozzles 220 is less than 15 degrees, the cleaning solution may be sprayed in a direction substantially perpendicular to the substrate S, and different streams of cleaning solution may be spread on substrate S from the two-fluid nozzles 220 and may interfere with each other. The cleaning solution might not be discharged from the substrate S, and may be stagnant.

When the installation polar angle θ4 of the two-fluid nozzles 220 is more than 45 degrees, the physical hitting force generated when the cleaning solution is spayed may be reduced, and the substrate S might not be uniformly cleaned.

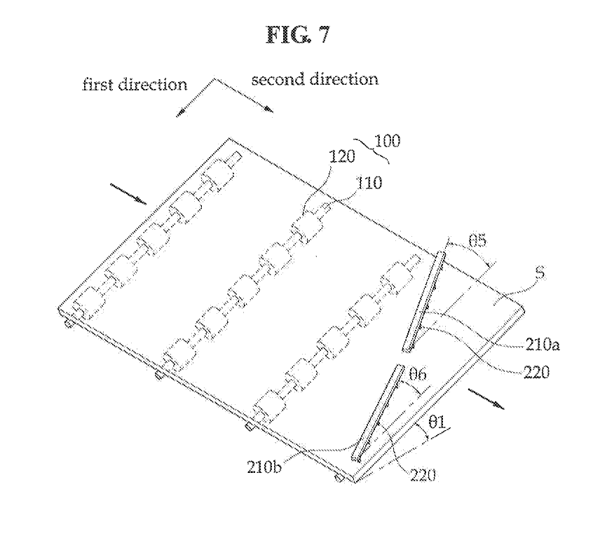

FIG. 7 is a diagram illustrating an apparatus for cleaning a substrate according to an exemplary embodiment of the present invention.

Referring to FIG. 7, the apparatus for cleaning a substrate according to an exemplary embodiment of the present invention may include a substrate transferring unit 100 configured to support a substrate S at a polar angle θ1 from a first direction. The substrate transferring unit 100 may be configured to transfer the substrate S along a second direction orthogonal to the first direction. The apparatus for cleaning a substrate may include a plurality of cleaning units 210a and 210b disposed on the substrate transferring unit 100, each including a plurality of two-fluid nozzles 220.

Hereinafter, a cleaning unit disposed on the upper part will be referred to as a “first sub-cleaning unit 210a” and a cleaning unit disposed on the lower part will be referred to as a “second sub-cleaning unit 210b.”

The first sub-cleaning unit 210a may be inclined to have an azimuth angle θ5 of 1 degree to about 89 degrees from the first direction, and the second sub-cleaning unit 210b may be inclined to have an azimuth angle θ6 of 1 degree to about 89 degrees from the first direction.

According to an exemplary embodiment of the present invention, each azimuth angle θ5 and θ6 of the first and second sub-cleaning units 210a and 210b may be in a range of about 15 degrees to 45 degrees, however, the azimuth angles θ5 and θ6 are not limited thereto. The azimuth angles θ5 and θ6 may be variable and may be in a range of about 1 degree to about 89 degrees.

According to an exemplary embodiment of the present invention, the azimuth angles θ5 and θ6 may have substantially the same value as each other or different values. According to an exemplary embodiment of the present invention, the azimuth angle θ5 of the first sub-cleaning unit 210a may have a higher value than the azimuth angle θ6 of the second sub-cleaning unit 210b.

When the azimuth angle θ5 of the first sub-cleaning unit 210a has a higher value than the azimuth angle θ6 of the second sub-cleaning unit 210b, cleaning may be sequentially performed from the upper part to the lower part of the substrate S. Particles removed from the upper part may flow to the lower part, and the particles may be prevented from re-adhering to the lower part of the substrate S.

According to an exemplary embodiment of the present invention, the cleaning unit 210 may be divided into two sub-cleaning units 210a and 210b. The cleaning unit 210 may be divided into three or more sub-cleaning units, and each of the sub-cleaning units may have different installation angles.

FIG. 7 illustrates a pair of the first and second sub-cleaning units 210a and 210b, however, the substrate transferring unit 100 may include a plurality of pairs of the first and second sub-cleaning units 210a and 210b.

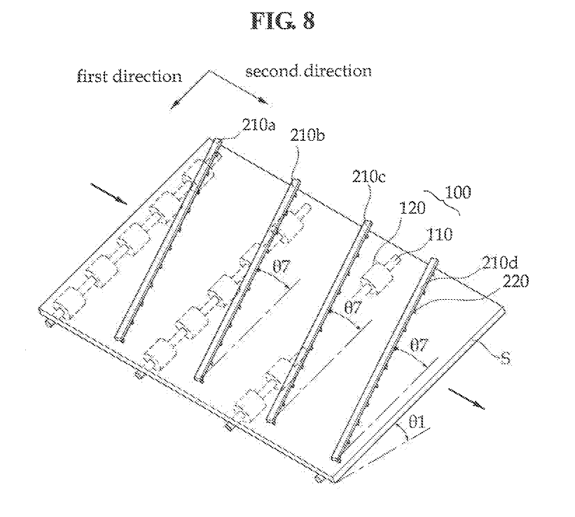

FIG. 8 is a diagram illustrating an apparatus for cleaning a substrate according to an exemplary embodiment of the present invention.

Referring to FIG. 8, the apparatus for cleaning a substrate according to an exemplary embodiment of the present invention may include a substrate transferring unit 100 configured to support a substrate S at a polar angle θ1 from a first direction. The substrate transferring unit 100 may be configured to transfer the substrate S along a second direction orthogonal to the first direction. The substrate transferring unit 100 may include a plurality of sub-cleaning units 210a, 210b, 210c, and 210d disposed on the substrate transferring unit 100, each including a plurality of two-fluid nozzles 220.

The plurality of sub-cleaning units 210a, 210b, 210c, and 210d may each have an azimuth angle θ7 of 1 degree to about 89 degrees from the first direction.

According to an exemplary embodiment of the present invention, the azimuth angle θ7 of the plurality of sub-cleaning units 210a, 210b, 210c, and 210d may be in a range of about 15 degrees to about 45 degrees, however, the azimuth angle θ7 is not limited thereto. The azimuth angle θ7 may be variable and may be in a range of 1 degree to about 89 degrees.

According to an exemplary embodiment of the present invention, at least one of the plurality of sub-cleaning units 210a, 210b, 210c, and 210d may have a different azimuth angle from other sub-cleaning units.

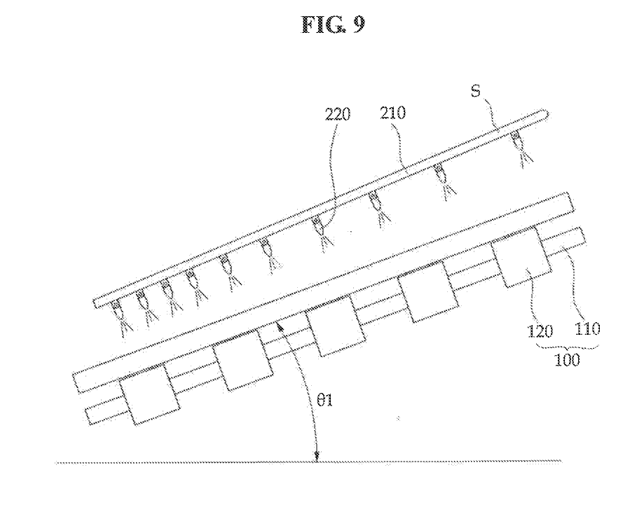

FIG. 9 is a diagram illustrating an apparatus for cleaning a substrate according to an exemplary embodiment of the present invention.

Referring to FIG. 9, the apparatus for cleaning a substrate according to an exemplary embodiment of the present invention may include a substrate transferring unit 100 configured to support a substrate S at a polar angle 01 from a first direction. The substrate transferring unit 100 may include a cleaning unit 210 disposed on the substrate transferring unit 100. The cleaning unit 210 may be configured to spray cleaning solution onto the substrate S through a plurality of two-fluid nozzles 220 disposed on the bottom portion of the cleaning unit 210.

According to an exemplary embodiment of the present invention, the distance between the two-fluid nozzles 220 may be in a range of about 30 mm to about 50 mm. However, the distance is not limited thereto, and may vary depending on type and size of the substrate S.

As illustrated in FIG. 9, for example, when the distance between the two-fluid nozzles 220 becomes gradually smaller from the upper part toward the lower part, a physical hitting force of the cleaning solution may increase toward the lower part. Reduction of the physical hitting force of cleaning solution, which may be caused by hydroplaning, may be prevented in the lower part.

While the present invention has been shown and described with reference to the exemplary embodiments thereof, it will be apparent to those of ordinary skill in the art that various changes in form and detail may be made thereto without departing from the spirit and scope of the invention as defined by the claims.

What is claimed is:

1. An apparatus for cleaning a substrate, comprising:
a substrate transferring unit configured to support a substrate at a polar angle from a first direction, and transfer the substrate along a second direction orthogonal to the first direction; and
a cleaning unit disposed on the substrate transferring unit, wherein the cleaning unit comprises a plurality of two-fluid nozzles, and
wherein the cleaning unit has an azimuth angle from the first direction, and the two-fluid nozzles are configured to mix a cleaning solution and compressed gas together and spray the mixture.

2. The apparatus for cleaning a substrate of claim 1, wherein the azimuth angle is about 10° to about 45°.

3. The apparatus for cleaning a substrate of claim 1, wherein the plurality of two-fluid nozzles are spaced apart from each other at a distance of about 30 mm to about 50 mm.

4. The apparatus for cleaning a substrate of claim 1, wherein the cleaning solution comprises deionized water (DIW).

5. The apparatus for cleaning a substrate of claim 1, wherein the substrate transferring unit has an angle of about 5° to about 20° from the cleaning unit.

6. The apparatus for cleaning a substrate of claim 1, wherein the plurality of two-fluid nozzles have a polar angle of about 15° to about 45° from a normal line perpendicular to the substrate.

7. The apparatus for cleaning a substrate of claim 1, wherein the cleaning unit comprises a plurality of sub-cleaning units, wherein at least two of the sub-cleaning units have different azimuth angles from the first direction.

8. The apparatus for cleaning a substrate of claim 7, wherein the plurality of sub-cleaning units comprise a first sub-cleaning unit disposed on an upper part of an inclined surface of the substrate; and a second sub-cleaning unit disposed on a lower part of the inclined surface of the substrate, and
wherein the first sub-cleaning unit has a larger azimuth angle than the second sub-cleaning unit.

9. The apparatus for cleaning a substrate of claim 1, wherein the cleaning unit comprises a plurality of sub-cleaning units having substantially the same azimuth angle from the first direction, and the plurality of sub-cleaning units are disposed substantially parallel to each other.

10. The apparatus for cleaning a substrate of claim 1, wherein a distance between the plurality of two-fluid nozzles becomes smaller from an upper part of the substrate to a lower part of the substrate.

11. An apparatus for cleaning a substrate, comprising:
a substrate transferring unit configured to hold a substrate and pivot to a polar angle with respect to a first direction;
a plurality of cleaning units disposed on the substrate transferring unit, wherein each of the plurality of cleaning units is configured to pivot to an azimuth angle with respect to the substrate transferring unit; and a plurality of two-fluid nozzles disposed on each of the plurality of cleaning units, wherein the two-fluid nozzles are configured to apply a cleaning solution mixture with a first force to an upper part of the substrate and a second force to a lower part of the substrate.

12. The apparatus of claim 11, wherein a distance between the plurality of two fluid nozzles on each of the plurality of cleaning units becomes smaller from the upper part of the substrate to the lower part of the substrate.

13. The apparatus of claim 11, wherein the azimuth angle is about 10° to about 45°.

14. The apparatus of claim 11, wherein the plurality of two-fluid nozzles are spaced apart from each other at a distance of about 30 mm to about 50 mm.

15. The apparatus of claim 11, wherein the cleaning solution mixture comprises deionized water (DIW).

16. The apparatus of claim 11, wherein the substrate transferring unit has an angle of about 5° to about 20° from the cleaning units.

17. The apparatus of claim 11, wherein the plurality of two-fluid nozzles have a polar angle of about 15° to about 45° from a normal line perpendicular to the substrate.

18. The apparatus of claim 11, wherein the substrate transferring unit further comprises one or more shafts comprising a plurality of rollers disposed on the shafts.

19. An apparatus for cleaning a substrate, comprising:
a substrate transferring unit configured to hold a substrate and pivot to a polar angle with respect to a first direction;
a plurality of cleaning units disposed on an upper part of the substrate transferring unit, wherein each of the plurality of cleaning units of the upper part of the substrate is configured to pivot to an azimuth angle with respect to the substrate transferring unit;
a plurality of cleaning units disposed on a lower part of the substrate transferring unit, wherein each of the plurality of cleaning units of the lower part of the substrate is configured to pivot to an azimuth angle with respect to the substrate transferring unit; and
a plurality of two-fluid nozzles disposed on each of the cleaning units, wherein the two-fluid nozzles are configured to apply a cleaning solution mixture with a first force to the upper part of the substrate and a second force to the lower part of the substrate.
